(19) United States
(12) Patent Application Publication
(10) Pub. No.: US 2022/0124848 A1
(43) Pub. Date: Apr. 21, 2022

(54) USER EQUIPMENT

(71) Applicant: NTT DOCOMO, INC., Tokyo (JP)

(72) Inventors: Shohei Yoshioka, Chiyoda-ku, Tokyo (JP); Kazuaki Takeda, Chiyoda-ku, Tokyo (JP); Shinpei Yasukawa, Chiyoda-ku, Tokyo (JP); Tomoki Maruko, Chiyoda-ku, Tokyo (JP)

(73) Assignee: NTT DOCOMO, INC., Tokyo (JP)

(21) Appl. No.: 17/428,072

(22) PCT Filed: Feb. 14, 2019
(86) PCT No.: PCT/JP2019/005439

§ 371 Date: Aug. 3, 2021

(51) Int. Cl. H04W 76/14; H04W 8/24; H04W 76/30

(52) U.S. Cl. CPC H04W 76/14; H04W 76/30; H04W 8/24

(57) ABSTRACT

Provided is a user equipment including a transmitting unit that indicates release information of a wireless communication system supported by the user equipment to another user equipment and a receiving unit that receives release information of a wireless communication system supported by the another user equipment from the another user equipment. The another user equipment supports terminal-to-terminal direct communication.

### TECHNICAL FIELD

The present invention relates to a user equipment in a wireless communication system.

### BACKGROUND ART

In Long Term Evolution (LTE) and systems following LTE (for example, LTE Advanced (LTE-A) and New Radio (NR) (also referred to as 5G)), sidelink (also referred to as Device to Device (D2D)) technology has been examined in which communication devices, such as UEs, directly communicate with each other without passing through a base station (Non-Patent Document 1).

In addition, technology for achieving Vehicle to Everything (V2X) has been discussed and specified. Here, V2X is a part of Intelligent Transport Systems (ITS) and is a general term of Vehicle to Vehicle (V2V) which means a communication form between vehicles, Vehicle to Infrastructure (V2I) which means a communication form between a vehicle and a road-side unit (RSU) provided on the side of the road, Vehicle to Nomadic device (V2N) which means a communication form between a vehicle and a mobile terminal of a driver, and Vehicle to Pedestrian (V2P) which means a communication form between a vehicle and a mobile terminal of a pedestrian.

### CITATION LIST

### Non-Patent Document

Non-Patent Document 1: 3GPP TS 36.213 V14.3.0 (2017-06)

### SUMMARY OF THE INVENTION

### Problem to be Solved by the Invention

In LTE, D2D is specified in Release 12 and Release 13 and V2X is specified in Release 14 and Release 15. For example, in LTE-V2X Release 15 updated from Release 14, functions, such as Carrier Aggregation (CA) and 64 Quadrature Amplitude Modulation (64QAM), are newly specified.

However, it is difficult for the user equipments to know each other's release information (the release information indicates the release number of a wireless communication system or the release number of the technology supported by the wireless communication system, such as LTE Release 12, LTE-V2X Release 15, or NR-V2X Release 16). Therefore, for example, it is difficult for a user equipment on the transmission side to determine whether or not a new function is supported by a user equipment on the reception side. That is, in a case in which the user equipment of a new release and the user equipment of an old release are both present, it is difficult to use a new function.

Further, since NR-V2X (V2X in NR) is further updated after Release 16 is completed, it is necessary to consider forward compatibility.

The invention has been made in view of the above-mentioned problems and an object of the invention is to provide a technique that can ensure forward compatibility in a user equipment which supports terminal-to-terminal direct communication. In addition, the invention is not limited to the terminal-to-terminal communication in V2X and may be applied to any terminal.

### Means for Solving Problem

According to a technique of the present disclosure, there is provided a user equipment including: a transmitting unit that indicates release information of a wireless communication system supported by the user equipment to another user equipment; and a receiving unit that receives release information of a wireless communication system supported by the another user equipment from another user equipment. The another user equipment supports terminal-to-terminal direct communication.

### Effect of the Invention

According to the technique of the present disclosure, there is provided a technique that can ensure forward compatibility in a user equipment which supports terminal-to-terminal direct communication.

### BRIEF DESCRIPTION OF DRAWINGS

FIG. 1 is a diagram for describing an SL transmission mode in NR-V2X;

FIG. 2 is a diagram for describing the problem to be solved;

FIG. 3 is a diagram for describing a MAC header;

FIG. 4 is a diagram illustrating an example of the functional configuration of a user equipment 20 according to an embodiment; and

FIG. 5 is a diagram illustrating an example of the hardware configuration of the user equipment 20 according to the embodiment.

### MODE(S) FOR CARRYING OUT THE INVENTION

Hereinafter, embodiments (these embodiments) of the invention will be described with reference to the drawings. The embodiments described below are only examples and the embodiments to which the invention is applied are not limited to the following embodiments.

(Communication Type in NR-V2X)

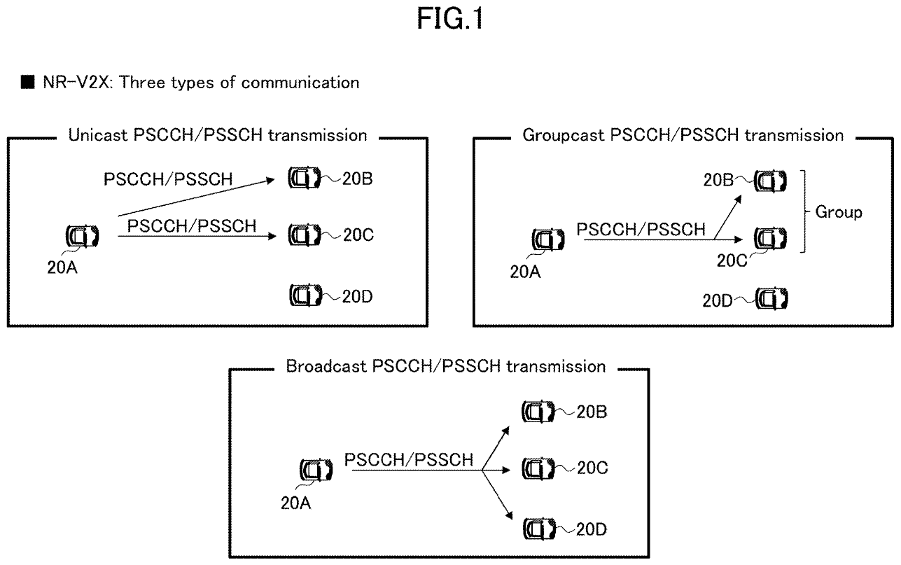

FIG. 1 is a diagram for describing communication types (Unicast, Groupcast, and Broadcast) in NR-V2X. In Unicast transmission, a user equipment 20A transmits Physical Sidelink Control Channel (PSCCH)/Physical Sidelink Shared Channel (PSSCH) to each of a user equipment 20B and a user equipment 20C. In Groupcast transmission, the user equipment 20A transmits PSCCH/PSSCH to a group formed by the user equipment 20B and the user equipment 20C. In Broadcast transmission, the user equipment 20A broadcasts PSCCH/PSSCH to the user equipment 20B, the user equipment 20C, and a user equipment 20D.

In the following description, in a case in which an arbitrary user equipment is indicated, the user equipment is described as a user equipment 20.

### Problem to be Solved

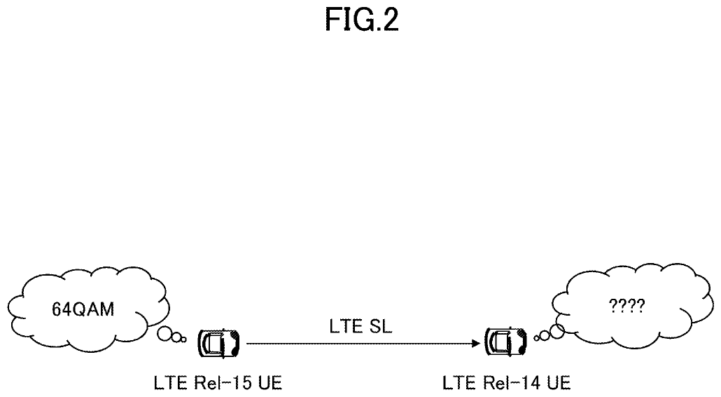

FIG. 2 is a diagram for describing the problem to be solved.

As illustrated in FIG. 2, in a case in which an LTE Release 15 user equipment and an LTE Release 14 user equipment are both present, it is difficult for an LTE Release 15 user equipment on a transmission side to know the release information of an LTE Release 14 user equipment on a reception side. Therefore, it is difficult for the LTE Release 15 user equipment on the transmission side to determine whether or not to perform transmission using 64QAM which is a function newly supported by LTE Release 15.

The invention has been made in order to solve such a problem.

### Embodiment 1

As Embodiment 1, it is considered that the user equipment performs indication of its own release information.

The release information may be indicated through Physical Sidelink Broadcast Control Channel (PSBCH).

The release information may be indicated through PSCCH. In this case, a new SCI format dedicated for indicating the release information may be defined. In addition, PSCCH may be periodically transmitted. The period in which PSCCH is transmitted may be configured (in advance). Further, an SCI field indicating the release information may be configured by a plurality of bits so as to correspond to a plurality of future releases.

The release information may be indicated through PSSCH. In this case, the information of an upper layer may include the release information.

A method for indicating the release information may be Broadcast, Groupcast, or Unicast.

### Embodiment 2

As Embodiment 2, it is considered that the user equipment is requested by other user equipments so as to feedback release information. In this case, the release information does not need to be periodically indicated. In addition/alternatively, in a case in which a certain user equipment does not retain the release information of a user device with which communication is desired, it is possible to obtain the release information without waiting for the next indication period.

The request may be transmitted to the user equipment through PSCCH or PSSCH.

A response to the request may be transmitted by Unicast, Groupcast, or Broadcast through PSCCH, PSSCH, or Physical Sidelink Feedback Channel (PSCCH).

### Embodiment 3

As Embodiment 3, in a case in which a user equipment receives release information older than its own release information from another user equipment, it is considered that the user equipment does not use a function that is included in the functions corresponding to its own release information, but is not included in the functions corresponding to the release information of the another user equipment.

In addition, a PHY layer that has received release information from another user equipment may indicate, to a MAC layer, the release information received from the another user equipment.

### Embodiment 4

As Embodiment 4, release information may be configured by a plurality of bits so as to correspond to a plurality of future releases. In this case, the value of the release information may be increased as the release information becomes new. For example, 3-bit release information may be used, and the value of NR Release 16 may be 000, the value of NR Release 17 may be 001, and the value of NR Release 18 may be 010.

In addition, the value of the release information may be decreased as the release information becomes new.

The term “release” may be replaced with, for example, “category” or “supportable features”.

### Embodiment 5

As Embodiment 5, it is considered that LTE release information may be indicated via NR sidelink (NR-SL).

One indication may include both NR release information and LTE release information.

Whether NR release information or LTE release information is indicated may be determined by, for example, indication resources, an SCI format, and scrambling RNTI.

### Embodiment 6

As Embodiment 6, it is considered that whether or not NR-SL is supported is indicated via LTE sidelink (LTE-SL).

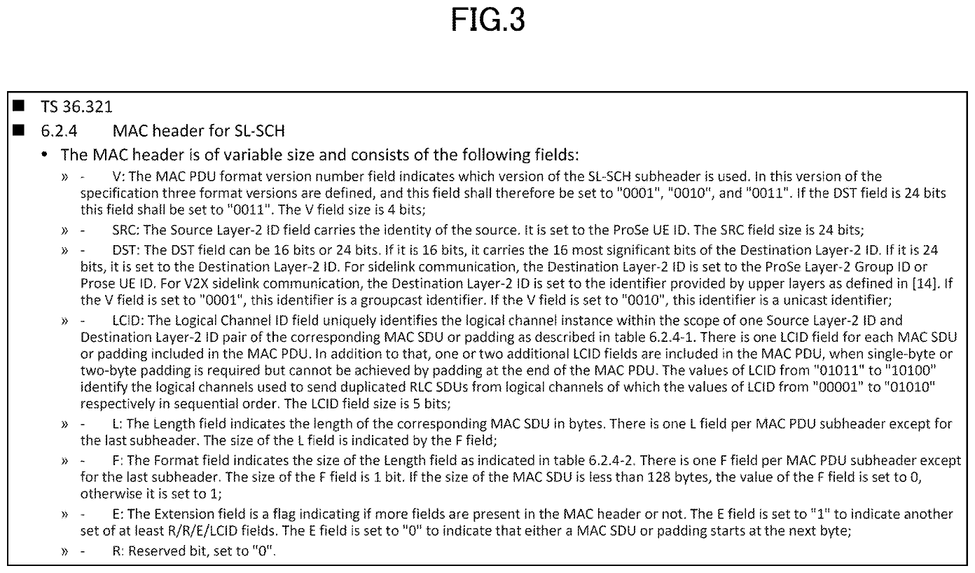

In a case in which whether or not NR-SL is supported is indicated via LTE-SL, a MAC header (see FIG. 3) for LTE SL-SCH may be used.

As one use case in a case of indicating whether or not NR-SL is supported on LTE-SL, for example, the following case is considered: when a periodic signal, such as a basic safety message, is transmitted on LTE-SL and the transmission of an aperiodic signal is required, whether or not NR-SL is supported is determined using LTE-SL; and, when NR-SL is supported, whether or not unicast is available is determined using LTE-SL.

Here, as illustrated in FIG. 3, the size of the MAC header for LTE SL-SCH is variable and the MAC header includes fields, such as a V field, an SRC field, a DST field, an LCID field, an L field, an F field, an extended field (E field), and a reserve field (R field).

As a method for indicating whether or not NR-SL is supported via LTE-SL, for example, the extended field, the reserve field, and the LCID field in the MAC header may be used.

Further, a UE ID included in the MAC header may include capability information including available information. All or a part of the UE ID may be the same between LTE-SL and NR-SL and may be the same between a MAC layer (layer 2) and a PHY layer (layer 1). In addition, all or a part of the UE ID of one radio access network (RAT) may be calculated (derived) from the UE ID of the other RAT or all or a part of the UE ID of one layer may be calculated (derived) from the UE ID of the other layer. For example, the UE ID of NR may be derived from the UE ID of LTE.

The capability information of LTE-SL and the capability information of NR-SL may be shared in the upper layers of LTE-SL and NR-SL.

(Effects)

As the effects obtained by the embodiments of the invention, a new release user equipment can perform communication using a new release function when communicating with a new release user equipment. In contrast, when communicating with an old release user equipment, the new release user equipment can perform communication without using the new release function.

(Apparatus Configuration)

Next, an example of the functional configuration of the user equipment 20 that performs the above-mentioned processes and operations will be described. The user equipment 20 has a function of implementing the above-described embodiments. However, the user equipment 20 may have only some of the functions described in the embodiments.

<User Equipment 20>

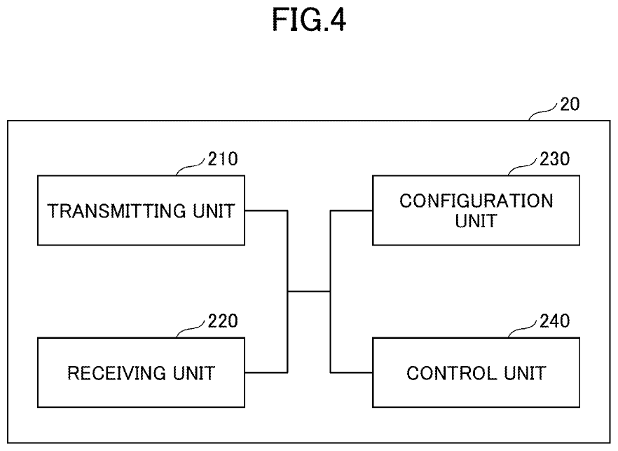

FIG. 4 is a diagram illustrating an example of the functional configuration of the user equipment 20. As illustrated in FIG. 4, the user equipment 20 includes a transmitting unit 210, a receiving unit 220, a configuration unit 230, and a control unit 240. The functional configuration illustrated in FIG. 4 is only an example. The functional units may have any functions and any names as long as they can perform the operations according to the embodiments of the invention.

The transmitting unit 210 creates a transmission signal from transmission data and wirelessly transmits the transmission signal. The receiving unit 220 wirelessly receives various signals and acquires signals of an upper layer from the received signals of a physical layer. In addition, the receiving unit 220 has a function of receiving SL scheduling transmitted from the base station apparatus. For example, the transmitting unit 210 transmits PSFCH/PSCCH/PSSCH to other user equipments 20 using V2X and the receiving unit 220 receives PSFCH/PSCCH/PSSCH from other user equipments 20. In addition, the transmitting unit 210 transmits its own release information to other user equipments 20 and the receiving unit 220 receives the release information of other user equipments 20.

The configuration unit 230 stores various kinds of configuration information received from the base station apparatus or the user equipment 20 by the receiving unit 220 in the storage device and reads the information from the storage device if necessary. In addition, the configuration unit 230 stores configuration information which has been configured in advance. The content of the configuration information includes, for example, information related to V2X and HARQ processes.

The control unit 240 performs V2X and HARQ processes. A functional unit related to signal transmission in the control unit 240 may be included in the transmitting unit 210 and a functional unit related to signal reception in the control unit 240 may be included in the receiving unit 220.

(Hardware Configuration)

The functional configuration diagram (FIG. 4) used in the description of the above-mentioned embodiments of the invention illustrates the blocks of the functional units. The functional blocks (configuration units) are implemented by any combination of hardware and/or software. A means for implementing each functional block is not particularly limited. That is, each functional block may be implemented by one apparatus configured by physically and/or logically combining a plurality of elements or by connecting two or more apparatuses, which are physically and/or logically separated from each other, directly and/or indirectly (for example, wirelessly and/or in a wired manner) and using the plurality of apparatuses.

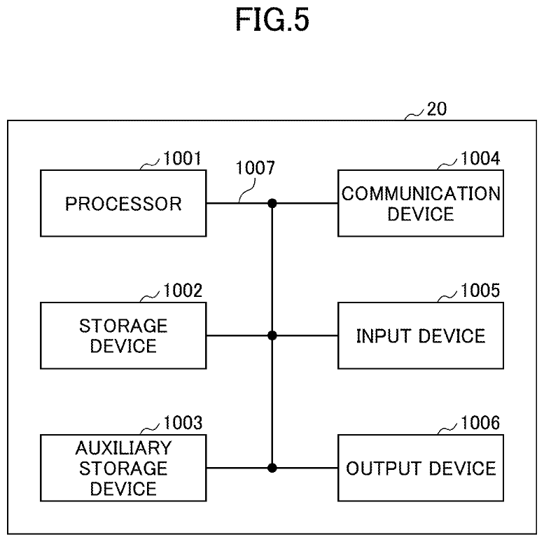

For example, the user equipment 20 according to an embodiment of the invention may function as a computer that performs the process according to the embodiment of the invention. FIG. 5 is a diagram illustrating an example of the hardware configuration of a wireless communication device which is the user equipment 20 according to the embodiment of the invention. The user equipment 20 may be physically configured as a computer apparatus that includes, for example, a processor 1001, a storage device 1002, an auxiliary storage device 1003, a communication device 1004, an input device 1005, an output device 1006, and a bus 1007.

In the following description, the term “apparatus” can be replaced with, for example, a circuit, a device, or a unit. The hardware configuration of the user equipment 20 may be configured to include one or more of the devices represented by reference numerals 1001 to 1006 in FIG. 5 or may be configured not to include some of the devices.

Each of the functions of the user equipment 20 is implemented by loading predetermined software (program) onto hardware, such as the processor 1001 and the storage device 1002, and causing the processor 1001 to perform an operation to control communication by the communication device 1004 and the reading and/or writing of data from and/or to the storage device 1002 and the auxiliary storage device 1003.

For example, the processor 1001 operates an operating system to control the entire computer. The processor 1001 may be a central processing unit (CPU) including, for example, an interface with peripheral devices, a control device, an arithmetic device, and a register.

The processor 1001 reads a program (program code), a software module, or data from the auxiliary storage device 1003 and/or the communication device 1004 to the storage device 1002 and performs various processes according to the read program, software module, or data. As the program, a program that causes the computer to perform at least some of the operations described in the above-mentioned embodiments is used. For example, the transmitting unit 210, the receiving unit 220, the configuration unit 230, and the control unit 240 of the user equipment 20 illustrated in FIG. 4 may be implemented by a control program that is stored in the storage device 1002 and is operated by the processor 1001. In the above description, the various processes are performed by one processor 1001. However, the various processes may be performed sequentially or at the same time by two or more processors 1001. The processor 1001 may be implemented by one or more chips. The program may be transmitted from the network through a telecommunication line.

The storage device 1002 is a computer-readable recording medium and may be configured by, for example, at least one of a read only memory (ROM), an erasable programmable ROM (EPROM), an electrically erasable programmable ROM (EEPROM), and a random access memory (RAM). The storage device 1002 may be referred to as, for example, a register, a cache, or a main memory (main storage device). The storage device 1002 can store, for example, an executable program (program code) or a software module for performing the process according to an embodiment of the invention.

The auxiliary storage device 1003 is a computer-readable recording medium and may be configured by, for example, at least one of an optical disc, such as a compact disc ROM (CD-ROM), a hard disk drive, a flexible disk, a magneto-optical disk (for example, a compact disk, a digital versatile disk, or a Blu-ray (registered trademark) disk), a smart card, a flash memory (for example, a card, a stick, or a key drive), a Floppy (registered trademark) disk, and a magnetic strip. The auxiliary storage device 1003 may also be referred to as an auxiliary storage device. The above-mentioned storage medium may be, for example, a database, a server, or other appropriate media including the storage device 1002 and/or the auxiliary storage device 1003.

The communication device 1004 is hardware (transmitting and receiving device) for communication between computers through a wired network and/or a wireless network and is referred to as, for example, a network device, a network controller, a network card, or a communication module. For example, the transmitting unit 210 and the receiving unit 220 of the user equipment 20 may be implemented by the communication device 1004.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may be integrated (for example, a touch panel).

The devices, such as the processor 1001 and the storage device 1002, are connected to each other by the bus 1007 for information communication. The bus 1007 may be a single bus or different buses between the devices.

The user equipment 20 may include hardware, such as a microprocessor, a digital signal processor (DSP), an application specific integrated circuit (ASIC), a programmable logic device (PLD), and a field programmable gate array (FPGA) and some or all of the functional blocks may be implemented by the hardware. For example, the processor 1001 may be implemented by at least one of the hardware components.

### Summary of Embodiments

As described above, according to an embodiment of the invention, there is provided a user equipment comprising: a transmitting unit that indicates release information of a wireless communication system supported by the user equipment to another user equipment; and a receiving unit that receives release information of a wireless communication system supported by the another user equipment from the another user equipment. The another user equipment supports terminal-to-terminal direct communication.

The above-mentioned configuration makes it possible to ensure forward compatibility in the user equipment that supports terminal-to-terminal direct communication.

The receiving unit may receive a release information request from another user equipment.

The user equipment may further include a control unit that does not use a function which is included in functions corresponding to the release information of the user equipment, but is not included in functions corresponding to the release information received from the another user equipment in a case in which the release information received from the another user equipment is older than the release information of the user equipment.

A value of the release information may be increased as the release information becomes new or may be decreased as the release information becomes new.

The transmitting unit may indicate LTE release information of the user equipment to another user equipment through NR terminal-to-terminal direct communication.

The transmitting unit may indicate the release information of the user equipment or information indicating whether or not the user equipment supports NR terminal-to-terminal direct communication through LTE terminal-to-terminal direct communication.

### Supplement of Embodiments

The embodiments of the invention have been described above. However, the disclosed invention is not limited to the embodiments. Those skilled in the art can understand various modifications, corrections, substitutions, replacements, and the like. The description has been made using specific numerical examples in order to facilitate the understanding of the invention. These numerical values are only examples and any appropriate values may be used unless otherwise stated. The classification of the items in the above description is not essential, but matters described in two or more items may be combined and used if necessary or matters described in a certain item may be applied to matters described in other items (unless the matters are inconsistent). The boundaries of the functional units or the processing units in the functional block diagrams may not necessarily correspond to the boundaries of physical components. The operations of a plurality of functional units may be performed physically by one component or the operation of one functional unit may be performed physically by a plurality of components. For the process procedures described in the embodiments, the order of the processes may be switched without being inconsistent. In order to facilitate the description of the processes, the user equipment 20 has been described with reference to the functional block diagram. However, the apparatus may be implemented by hardware, software, or a combination thereof. Software operated by the processor included in the user equipment 20 according to the embodiments of the invention may be stored in a random access memory (RAM), a flash memory, a read-only memory (ROM), an EPROM, an EEPROM, a register, a hard disk drive (HDD), a removable disk, a CD-ROM, a database, a server, or other appropriate storage media.

The indication of information is not limited to the aspects/embodiments described in the specification and may be performed by other methods. For example, the indication of information may be performed by physical layer signaling (for example, downlink control information (DCI) or uplink control information (UCI)), upper layer signaling (for example, radio resource control (RRC) signaling, medium access control (MAC) signaling, or broadcast information (a master information block (MIB) or a system information block (SIB)), other signals, or a combination thereof. The RRC signaling may also be referred to as an RRC message. For example, the RRC signaling may be an RRC connection setup message or an RRC connection reconfiguration message.

Each aspect/embodiment described in the specification may be applied to systems using Long Term Evolution (LTE), LTE-Advanced (LTE-A), SUPER 3G, IMT-Advanced, 4G, 5G, Future Radio Access (FRA), W-CDMA (registered trademark), GSM (registered trademark), CDMA2000, Ultra Mobile Broadband (UMB), IEEE 802.11 (Wi-Fi), IEEE 802.16 (WiMAX), IEEE 802.20, Ultra-WideBand (UWB), Bluetooth (registered trademark), and other appropriate systems and/or next-generation systems extended on the basis of these systems.

For example, the order of the process procedures, the sequence, and the flowchart in each aspect/embodiment described in the specification may be interchanged as long as there is no contradiction. For example, in the method described in the specification, elements of various steps are presented in an exemplary order and the invention is not limited to the presented specific order.

In the specification, a specific operation performed by the base station apparatus may also be performed by an upper node according to circumstances. In a network including one network node or a plurality of network nodes having the base station apparatus, it is clear that various operations performed to communicate with the user equipment 20 can be performed by the base station apparatus and/or a network node (for example, MME or S-GW is considered, but the network node is not limited thereto) other than the base station apparatus. The case in which the number of network nodes other than the base station apparatus is 1 has been exemplified above. However, a plurality of other network nodes (for example, MME and S-GW) may be combined with each other.

The aspects/embodiments described in the specification may be independently used, may be combined and used, or may be switched and used in association with execution.

The user equipment 20 may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms, depending on the person skilled in the art.

The base station apparatus may be referred to as NodeB (NB), evolved NodeB (eNB), gNB, a base station, or some other suitable terms, depending on the person skilled in the art.

The term “determining” used in the specification includes a wide variety of operations in some cases. The “determining” can include cases in which performing, for example, judging, calculating, computing, processing, deriving, investigating, looking up (for example, looking up in a table, a database, or other data structures), and ascertaining is considered to perform “determining”. In addition, the “determining” can include cases in which performing, for example, receiving (for example, receiving information), transmitting (for example, transmitting information), inputting, outputting, and accessing (for example, accessing data in a memory) is considered to perform “determining”. Further, the “determining” can include cases in which performing, for example, resolving, selecting, choosing, establishing, and comparing is considered to perform “determining”. That is, the “determining” can include a case in which any operation is considered to perform “determining”.

The term “based on” used in the specification does not mean “based on only” unless otherwise stated. In other words, the term “based on” means both “based on only” and “based on at least”.

The terms “include”, “including”, and modifications thereof are intended to be inclusive as in the term “comprising” as long as they are used in the specification or the claims. Further, the term “or” used in the specification or the claims is not intended to be an exclusive OR.

In the entire present disclosure, for example, in a case in which the articles, such as a, an, and the, in English are added in translation, the articles may indicate plurality if they do not clearly indicate singular nouns in the context.

In the embodiments of the invention, the signal transmitted through PSFCH, PSCCH and/or PSSCH is an example of the signal in terminal-to-terminal direct communication.

The invention has been described in detail above. However, it should be apparent to those skilled in the art that the invention is not limited to the embodiments described in the specification. The invention can be embodied as corrected and changed aspects without departing from the scope and spirit of the invention defined by the claims. Therefore, the description of the specification has been made for exemplary description and is not intended to have any restrictive meaning to the invention.

### EXPLANATIONS OF LETTERS OR NUMERALS

10 BASE STATION APPARATUS
110 TRANSMITTING UNIT
120 RECEIVING UNIT
130 CONFIGURATION UNIT
140 CONTROL UNIT
20 USER EQUIPMENT
210 TRANSMITTING UNIT
220 RECEIVING UNIT
230 CONFIGURATION UNIT
240 CONTROL UNIT
1001 PROCESSOR
1002 STORAGE DEVICE
1003 AUXILIARY STORAGE DEVICE
1004 COMMUNICATION DEVICE
1005 INPUT DEVICE
1006 OUTPUT DEVICE

1. A user equipment comprising:
a transmitting unit that indicates release information of a wireless communication system supported by the user equipment to another user equipment; and
a receiving unit that receives release information of a wireless communication system supported by the another user equipment from the another user equipment,
wherein the another user equipment supports terminal-to-terminal direct communication.

2. The user equipment according to claim 1,
wherein the receiving unit receives a release information request from the another user equipment.

3. The user equipment according to claim 1, further comprising:
a control unit that does not use a function which is included in functions corresponding to the release information of the user equipment, but is not included in functions corresponding to the release information received from the another user equipment in a case in which the release information received from the another user equipment is older than the release information of the user equipment.

4. The user equipment according to claim 1,
wherein a value of the release information is increased as the release information becomes newer or is decreased as the release information becomes newer.

5. The user equipment according to claim 1,
wherein the transmitting unit indicates LTE release information of the user equipment to the another user equipment through NR terminal-to-terminal direct communication.

6. The user equipment according to claim 1,
wherein the transmitting unit indicates the release information of the user equipment or information indicating whether or not the user equipment supports NR terminal-to-terminal direct communication through LTE terminal-to-terminal direct communication.
